(19) United States
(12) Patent Application Publication
(10) Pub. No.: US 2002/0144291 A1
(43) Pub. Date: Oct. 3, 2002

(54) Network publication of data synchronized with television broadcasts

(76) Inventors: Mary Smiley, Beaverton, OR (US); Sridhar Iyengar, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/820,062

(22) Filed: Mar. 28, 2001

(51) Int. Cl. H04N 7/173

(52) U.S. Cl. 725/120; 725/114; 725/118

(57) ABSTRACT

Distribution of ATVEF type broadcasts over a network. Generally, an ATVEF receiving site receives ATVEF data that is published along with a television or other broadcast. The ATVEF receiving site then transcodes the ATVEF data into a second format for distribution across a network. A viewer may then receive the ATVEF data with an appropriate receiver according to the second format. For example, ATVEF data may be received by the ATVEF receiver, transcoded into content made available by to a web browser, and then received on a wireless Internet browser used by a viewer.

### FIELD OF THE INVENTION

The invention generally relates to television broadcasting, and more particularly to enhancing television broadcasts with synchronized and asynchronous companion services and data, such as ATVEF data.

### BACKGROUND

It is desirable to be able to synchronously deliver services or data along with a television broadcast. Towards this end, the Advanced Television Enhancement Forum (ATVEF), resulting from a consortium of broadcast, cable and computer companies, developed an HTML and JavaScript-based format for associating digital content with television broadcasts. The general concept is to synchronize enhancing data, such as game show content, related items for sale, or other arbitrary content presentations with a broadcast, and have the synchronized content presented to a viewer.

Presently there are two types of ATVEF content. The first, called Type A, comprises embedding a Uniform Resource Locator (URL) within the vertical blank interrupt (VBI) of a conventional television broadcast signal. An ATVEF receiver, such as a Microsoft Web TV device, receives the URL and loads network content referenced by the URL. (Please note that all marks used herein are the property of their respective owners.) A significant limitation of conventional television broadcasts, however, is limited bandwidth provided by the VBI. The second type of ATVEF content, called Type B, comprises embedding rich content within a digital broadcast channel. Each digital broadcast channel includes audiovisual data, and a data channel providing 19.2 megabits per second of data transfer for embedded rich content intended to enhance the accompanying audiovisual data.

A significant limitation to ATVEF types of content distributions is that dedicated decoding hardware required to receive and decode the ATVEF data. That is, each viewer is required to have a Web TV, Tivoli, or other dedicated hardware that can receive and proves the ATVEF content.

### BRIEF DESCRIPTION OF THE DRAWINGs

The features and advantages of the present invention will become apparent from the following detailed description of the present invention in which:

FIG. 1 illustrates a prior art configuration for delivery of ATVEF content.

FIG. 2 illustrates one embodiment of the invention that overcomes the requirement for dedicated ATVEF decoding hardware.

FIG. 3 is a flowchart illustrating one embodiment for leveraging the power of a personal computer to process ATVEF data that is transmitted 300 along with a television broadcast.

FIG. 4 illustrates a suitable computing environment in which certain aspects of the invention may be implemented.

### DETAILED DESCRIPTION

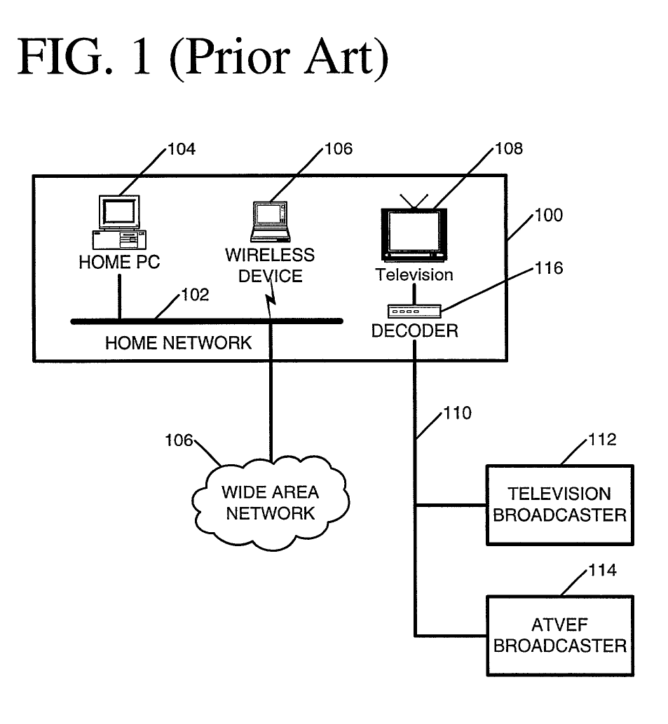

FIG. 1 illustrates an exemplary prior art configuration for delivery of ATVEF data to a viewer home represented by box 100. As illustrated, the viewer home 100 has a home network 102, to which is attached a home computer (PC) 104 and a wireless device 106, such as an interactive tablet, personal digital assistant (PDA), wireless computer, gaming device, cellular telephone, or other wireless machine. The wireless device may be directly responsible for receiving and processing network content, as would a typical computer. Also within viewer home 100 is a television 108 which receives broadcasts over a communication path 110, which may include a terrestrial wireless broadcast environment, a wired (e.g., cable) environment, or other broadcast service.

As illustrated, a television broadcaster 112 is a source for a particular broadcast, and an ATVEF broadcaster 114 is responsible for providing ATVEF content in accord with a particular television broadcast. Although the ATVEF and television broadcaster are presented separately, they may be a single entity. To receive the broadcasted ATVEF content, a viewer home 100 is required to have an ATVEF decoder 116 to receive and decode the ATVEF data, e.g., the Microsoft Web TV product, or other decoding device. In addition, a machine, such as the home PC 104, may be configured with an ATVEF decoder card.

One significant limitation to this exemplary prior art configuration is that requiring an ATVEF decoding device 116 for every television is costly. Another limitation is the restrictive ability to upgrade decoding equipment to keep pace with technological advances. Presently, in order to effect an upgrade to an existing decoder, either a service call must be made to physically upgrade a decoder, a user must send in the device for an upgrade and deprive themselves of the decoder in the upgrade interim, or decoders must be built with more costly components and designs to allow field upgrades from a remote location, e.g., from the ATVEF broadcaster 114.

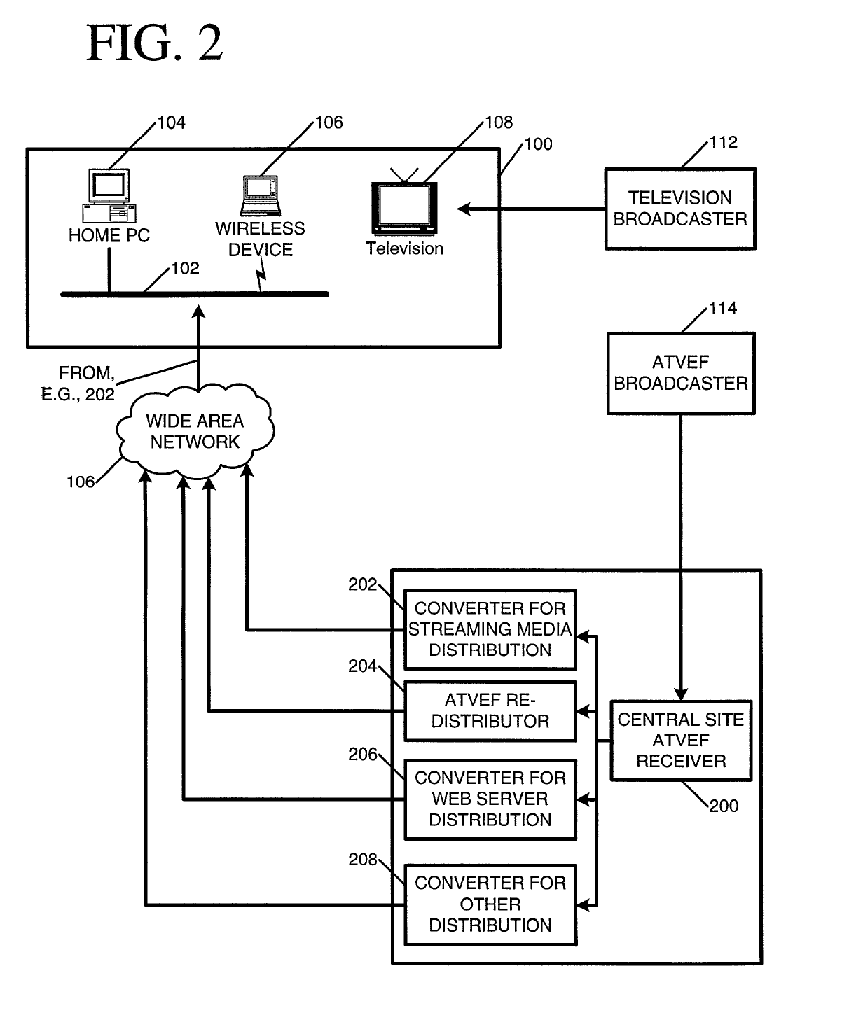

FIG. 2 illustrates one embodiment for overcoming the requirement for dedicated ATVEF decoding hardware. Note that references to a “home” environment are illustrative only, and that different environments, such as workplaces, educational institutions, etc., are within the scope and intent of the present invention. In addition, it will be appreciated to one skilled in the art that even though this description focuses on ATVEF data, the present invention is generally applicable to other environments in which content is synchronously delivered along with a television broadcast.

In the illustrated embodiment, rather than directly sending ATVEF data directly to a decoder box 116 (FIG. 1) as discussed above, instead ATVEF data is received by a central ATVEF receiving site 200. The ATVEF receiving site 200 then utilizes converters to transcode received ATVEF data in a format suitable for distribution to a viewer home 100 over a network 106, e.g., wired or wireless networks such as an intranet, the Internet, etc. In one embodiment, the ATVEF data is distributed as TCP/IP network traffic, however it will be appreciated by the skilled artisan that other protocols may be used, and that over time, as network technologies improve, different protocols may be more optimal for ATVEF data distribution.

Illustrated are exemplary transcoding converters for ATVEF broadcasts. Thus, for example, in one embodiment, there may be a converter 202 for converting ATVEF data into a streaming media format, e.g., such as one provided by Microsoft Corp., Real Networks, Inc., or other audio and/or visual format.

In one embodiment, there may be a converter 204 for re-distributing ATVEF data over the network 106 to a networked location otherwise unable to receive conventional ATVEF broadcasts. For example, the ATVEF content may be re-distributed over the network 106 to allow offloading of ATVEF processing, e.g., conversions, etc., to machines of the home network 102.

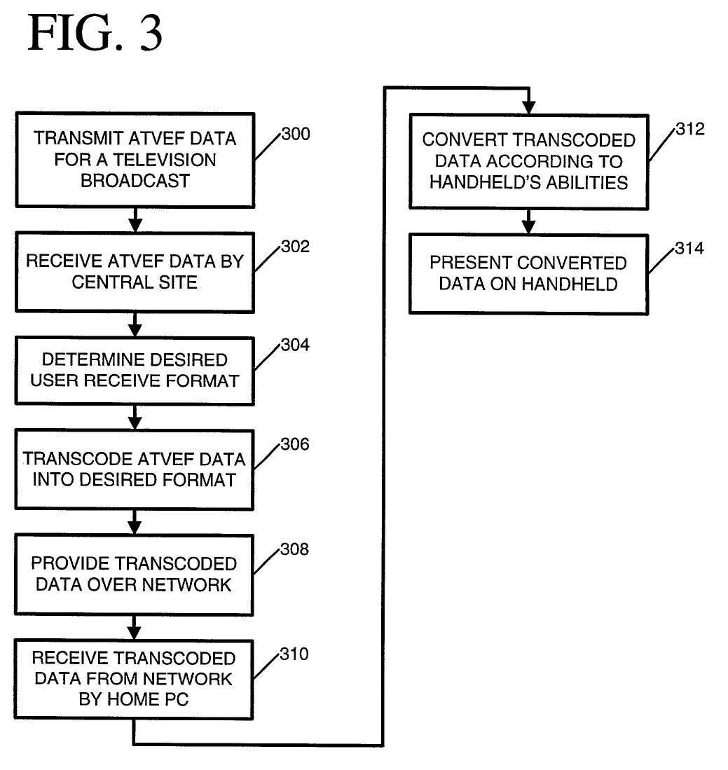

In one embodiment, there may be a converter 206 for re-distributing ATVEF data by way of a web server. In this embodiment, a web browser within a viewer home 100 (FIG. 1) may be used to contact the web server and display the ATVEF data. For example, a web browser operating on home PC 104 may load and interact with a web page identified by ATVEF data broadcasted along with a game show. In one embodiment, a web browser operates on a wireless handheld device 106, allowing a television viewer to more conveniently view the ATVEF data along with a television's 108 broadcast. This handheld device may be self-reliant, e.g., able to directly process ATVEF data, or the processing power of the home PC may be utilized to pre-process the ATVEF data and present it to the handheld device for display (see FIG. 3). Such a configuration allows for a simpler, and therefore less costly, handheld device.

In one embodiment, there may be a converter 208 for converting the ATVEF data into some other arbitrary format. It will be appreciated by one skilled in the art that a converter may be implemented to convert the ATVEF data into any desired format for transmission over the network 106. For example, converters may be implemented to tailor ATVEF content for display over cellular telephones, home appliances, watches, or other products comprising perceptible output. For devices such as cellular telephones, depending on the nature of the cellular telephone system, a bridge between the network 106 and the cellular switching network may be required. Note that the present invention applies to both two-dimensional broadcast environments, such as conventional television broadcasts, or immersion environments, e.g., large view-field environments such Omnimax, and three dimensional broadcast environments, such as virtual reality environments, stereoscopic displays, and the like.

It will be appreciated that different techniques can be applied to determine which of various available transcoding formats is to be sent to a particular viewer home (see FIG. 3). For example, a viewer home may register preferences with the central site 200. Alternatively, a viewer home may operate a service, server, or other responding device that the central site may query as to desired reception formats. In one embodiment, when a viewer home supports multiple reception formats, a test is performed to identify a more optimal transmission format. For example, network congestion may cause one format to perform more optimally than another.

FIG. 3 is a flowchart illustrating one embodiment for leveraging the power of a personal computer or other computing device to process ATVEF data that is transmitted 300 along with a television broadcast.

The ATVEF data is received 302 by a central site. For a particular viewer home, the central site determines 304 a desired format for the viewer home. Depending on the desired format, transcoded ATVEF data may be pushed to the viewer home, or made available for pulling by the viewer home in the desired format. For example, if the desired format is browser based ATVEF receiver, then a web browser may pull content from the central site. In one embodiment, the central site offers a subscription service in which different rates are charged for different transcoding formats. Thus, once available formats are determined 304, a particular one may be utilized based on viewer home preferences.

The ATVEF data is transcoded 306 into the desired format, and provided 308 to the viewer home for receipt 310 through a network. For example, in a streaming media context, an appropriate streaming media server is configured to provide the transcoded data to a streaming media client of the viewer home.

In the illustrated embodiment, a computing device, such as a home PC 104 (FIG. 1), or other machine, receives 310 the transcoded data. The computing device then converts 312 the transcoded data into a format suitable for presentation 314 by a handheld device, e.g., a PDA, tablet, telephone, wireless handheld device, etc. Conversion is dependent on the capabilities of the handheld device, e.g., display size, color capabilities, input/output capabilities, memory capacity, etc. In one embodiment, capabilities are assumed, or known in advance, such as due to an install process indicating the capabilities.

In another embodiment, a discovery protocol is employed to determine the capabilities of the handheld device. For example, a wireless handheld device may automatically register its capabilities with the home PC when it comes into range of the home PC, or attaches to the home network. The home PC may then appropriately deliver the transcoded ATVEF data. Alternatively, the home PC may interrogate the handheld device when it comes into range of the home PC, or attaches to the home network.

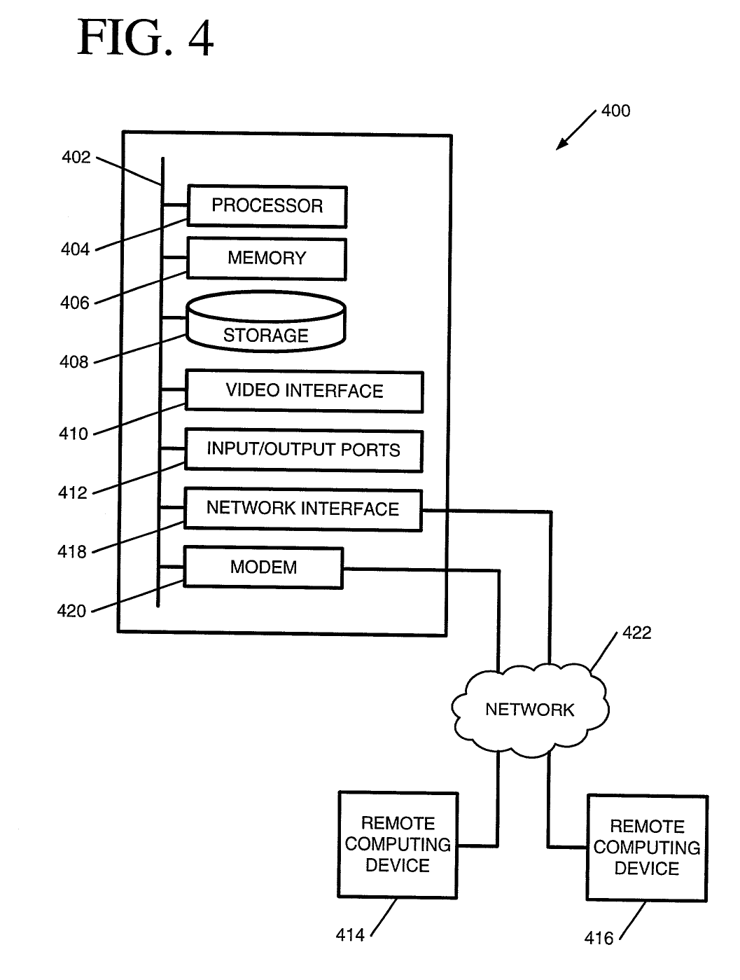

FIG. 4 and the following discussion are intended to provide a brief, general description of a suitable computing environment in which certain aspects of the illustrated invention may be implemented. For example, an exemplary system for embodying the home PC 104 or wireless device 106 of FIG. 1 includes a machine 400 having system bus 402 for coupling various machine components.

Typically, attached to the bus are processors 404, a memory 406 (e.g., RAM, ROM), storage devices 408, a video interface 410, and input/output interface ports 412. The machine may also include embedded controllers, Programmable Logic Devices (PLD), Programmable Logic Arrays (PLA), Programmable Array Logic (PAL), Generic Array Logic (GAL), Field-Programmable Gate Arrays (FPGA), Application Specific Integrated Circuits (ASIC), computers, smart cards, or another machine, system, etc.

The system is expected to operate in a networked environment using logical connections to one or more remote machines 414, 416 through a network interface 418, modem 420, or other communication pathway. For example, assuming the system comprises the home PC 104, then remote machine 414 may be the FIG. 2 central site ATVEF receiver 200. It will be appreciated that remote machines 414, 416 may be configured like machine 400, and therefore include many or all of the elements discussed for machine.

It should also be appreciated that machines 400, 414, 416 may be embodied within a single device, or separate communicatively-coupled components, and may include or be embodied within routers, bridges, peer devices, web servers, etc. Machines may be interconnected by way of a wired or wireless network 422 including an intranet such as home network 102, the Internet, local area networks, wide area networks, cellular, cable, laser, satellite, microwave, Blue Tooth, optical, infrared, or other carrier technology.

Memory 406, storage devices 408, and associated media, can store data and directives for the machine 400. The invention may be described by reference to different high-level program modules and/or low-level hardware contexts that may be stored in memory 406 and/or storage devices 408. Program modules include procedures, functions, programs, components, data structures, and the like, for performing particular tasks or implementing particular abstract data types. One skilled in the art will realize that program modules and low-level hardware contexts can be interchanged with low-level hardware instructions.

Program modules may be implemented within a single machine, or processed in a distributed network environment, and stored in both local and remote memory. Memory and storage devices include hard-drives, floppy-disks, optical storage, magnetic cassettes, tapes, flash memory cards, memory sticks, digital video disks, biological storage, and the like, as well as wired and wireless transmission environments, over which directives may be delivered in the form of packets, serial data, parallel data, or other suitable transmission format.

Having described and illustrated the principles of the invention with reference to illustrated embodiments, it will be recognized that the illustrated embodiments can be modified in arrangement and detail without departing from such principles.

And, even though the foregoing discussion has focused on particular embodiments, it is understood that other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments, and unless implicitly or expressly indicated otherwise, embodiments are combinable into other embodiments. Consequently, in view of the wide variety of permutations to the above-described embodiments, the detailed description is intended to be illustrative only, and should not be taken as limiting the scope of the invention.

What is claimed as the invention, therefore, is all such modifications as may come within the scope and spirit of the following claims and equivalents thereto.

What is claimed is:

1. A method for distributing enhancement data for a television broadcast comprising over a data network:
receiving enhancement data corresponding to the television broadcast in a first format compatible with a first transport;
converting the enhancement data into a second format compatible with a second transport different from the first delivery mechanism, wherein the second transport is the data network; and
providing said converted enhancement data to a client in accordance with the second transport.

2. The method of claim 1, further comprising:
receiving the television broadcast; and
extracting said enhancement data from the television broadcast.

3. The method of claim 1, wherein said received enhancement data comprises ATVEF encoded web page content.

4. The method of claim 1, further comprising:
pushing said converted enhancement data to the client.

5. The method of claim 1, further comprising:
providing said converted enhancement according to the second format for pulling thereof by the client to the client.

6. The method of claim 1, further comprising:
inspecting a client profile associated with the client; and
determining the second format based at least in part on said inspecting.

7. The method of claim 6, further comprising:
providing plural conversion formats including the second format;
associating delivery prices with each of said plural formats; and
selecting the second format of said plural formats based at least in part on said associated delivery prices and said inspecting the client profile.

8. The method of claim 1, further comprising:
providing plural conversion formats including the second format;
associating delivery prices with each of said plural formats; and
selecting the second format of said plural formats based at least in part on said associated delivery prices.

9. A method for distributing enhancement data for a television broadcast to a viewer of the television broadcast, comprising:
receiving enhancement data for the television broadcast over a first transport, said enhancement data having a first format in accordance with the first transport;
converting said enhancement data into a second format, different from the first format, for delivery of said converted enhancement data over a second transport different from the first transport, said second transport being a data network; and
providing said converted enhancement data to the viewer over the data network.

10. The method of claim 9, wherein the data network is the Internet.

11. The method of claim 9, further comprising:
pushing said converted enhancement data to the viewer over the data network according to the second format.

12. The method of claim 9, further comprising:
providing a server configured for the viewer to pull said converted enhancement data from the server over the data network according to the second format.

13. The method of claim 9, wherein the second format is selected from a set of formats consisting of: a streaming media format, a hypertext transport protocol (HTTP) format, a Java-type format, a JavaScript-type encoding format, a tag based encoding format, and a web page format.

14. A system for distributing enhancement data for a television broadcast to a viewer of the television broadcast, comprising:
a television broadcaster for broadcasting the television broadcast;
an enhancement data broadcaster for broadcasting said enhancement data over a first transport in a first format in accordance with the first transport; and
a central site for providing converted enhancement data to the viewer over a data network, the central site comprising:
a receiver for receiving said broadcasted enhancement data over the first transport; and
a converter for converting said enhancement data into a second format different from the first format for delivery over the data network.

15. The system of claim 14, wherein the television broadcaster also broadcasts said enhancement data.

16. The system of claim 14, further comprising:
wherein the television broadcast comprises an audiovisual component and an ATVEF data component comprising said enhancement data; and
wherein the receiver receives the television broadcast and extracts said enhancement data therefrom for conversion by the converter.

17. An apparatus for distributing enhancement data for a television broadcast comprising over a data network, comprising a readable medium having instructions encoded thereon for execution by a processor, said instructions capable of directing the processor to perform:
receiving enhancement data corresponding to the television broadcast in a first format compatible with a first transport;
converting the enhancement data into a second format compatible with a second transport different from the first delivery mechanism, wherein the second transport is the data network; and
providing said converted enhancement data to a client in accordance with the second transport.

18. The apparatus of claim 17, wherein said received enhancement data comprises ATVEF encoded web page content.

19. The apparatus of claim 17, said instructions including further instructions capable of directing the processor to perform:
inspecting a client profile associated with the client; and
determining the second format based at least in part on said inspecting.

20. An apparatus for distributing enhancement data for a television broadcast to a viewer of the television broadcast, comprising a readable medium having instructions encoded thereon for execution by a processor, said instructions capable of directing the processor to perform:
receiving enhancement data for the television broadcast over a first transport, said enhancement data having a first format in accordance with the first transport;
converting said enhancement data into a second format, different from the first format, for delivery of said converted enhancement data over a second transport different from the first transport, said second transport being a data network; and
providing said converted enhancement data to the viewer over the data network.

21. The apparatus of claim 20, wherein the second format is selected from a set of formats consisting of: a streaming media format, a hypertext transport protocol (HTTP) format, a Java-type format, a JavaScript-type encoding format, a tag based encoding format, and a web page format.

22. An apparatus for distributing enhancement data for a television broadcast comprising over a data network, comprising:
receiving means for receiving enhancement data corresponding to the television broadcast in a first format compatible with a first transport;
converting means for converting the enhancement data into a second format compatible with a second transport different from the first delivery mechanism, wherein the second transport is the data network; and
providing means for providing said converted enhancement data to a client in accordance with the second transport.

23. The apparatus of claim 22, further comprising:
receiving means for receiving the television broadcast; and
extracting means for extracting said enhancement data from the television broadcast.

24. The apparatus of claim 22, further comprising:
pushing means for pushing said converted enhancement data to the client.

25. The apparatus of claim 22, further comprising:
providing means for providing said converted enhancement according to the second format for pulling thereof by the client to the client.
